(19) United States
(12) Patent Application Publication
(10) Pub. No.: US 2002/0015637 A1
(43) Pub. Date: Feb. 7, 2002

(54) Straddle loader for ISO containers

(75) Inventors: Hermann Franzen, Monchengladbach (DE); Joachim Kroll, Juchen (DE)

Correspondence Address: COHEN, PONTANI, LIEBERMAN & PAVANE, Suite 1210, 551 Fifth Avenue, New York, NY, 10176, US

(73) Assignee: Atecs Mannesmann AG

(21) Appl. No.: 09/849,665

(22) Filed: May 4, 2001

(30) Foreign Application Priority Data
May 5, 2000 (DE) 100 23 076.8

(51) Int. Cl. B60P 3/00

(52) U.S. Cl. 414/458

(57) ABSTRACT

A straddle loader for ISO containers has a portal-like box girder at each end and longitudinal chassis girders a certain distance apart connecting the box girders, the longitudinal girders forming the base for the individual wheel suspensions of the traveling mechanism and for the attachment of a lifting device for the ISO containers. The straddle loader can be used passively, i.e., it can be loaded and unloaded from above through the open space between the longitudinal chassis girders and the box girders extending transversely between them. It can also be used actively, i.e., the straddle loader can be driven by its traveling mechanism installed on both sides of the longitudinal axis of the ISO container into a loading position above the ISO container, in which position the lifting bolts of the downward-extending grapplers, which are hinged to the two raisable and lowerable longitudinal girders of the lifting device, which are symmetrical to the longitudinal axis of the vehicle, can be pivoted into the lower corner fittings of the ISO containers. The number and position of the grapplers are selected in correspondence with the dimensions of the ISO container to be lifted.

### BACKGROUND OF THE INVENTION

1. Field of the Invention

The invention pertains to a straddle loader for ISO (International Organization for Standardization) containers with a portal-like box girder at each end, connected by longitudinal chassis girders a certain distance apart, which form the base for the individual wheel suspensions of the traveling mechanism and for the attachment of a lifting device for the ISO containers.

2. Description of the Related Art

Straddle loaders are often used to load and unload transport vehicles. Straddle loaders are vehicles which have the job of transporting freight units within container terminals. The known straddle loader is equipped with a conventional spreader, which is installed in the portal of the loader so that it can be raised and lowered and thus lowered onto and fastened to the freight unit to be transported. These spreaders, that is, the support frames and the gripping means attached to them, are equipped with various, often highly complicated devices for gripping and holding the freight units and thus are often heavy and expensive. These load lifters are unsuitable in particular for the automatic, rapid picking-up and setting-down of ISO containers, because the containers must be picked up and put down manually.

### SUMMARY OF THE INVENTION

The goal of the present invention is to create a straddle loader for ISO containers for use in container terminals, which, in driverless, automatic fashion, is able both to hold containers in passive mode and to transport them in active mode.

According to the invention, the straddle loader is designed to be used passively, that is, loaded and unloaded from above through the open space formed between the longitudinal chassis girders and the box girders extending transversely between longitudinal girders, and also actively, in that the straddle loader can be positioned by means of the traveling mechanism positioned on both sides of the longitudinal axis of the container and thus brought into a loading position above the ISO container, so that the lifting bolts of the downward-extending grapplers, which are hinged to two longitudinal raisable and lowerable girders of the lifting device symmetrical to the longitudinal axis of the vehicle, can be pivoted into the lower corner fittings of the ISO containers. The number and position of the grapplers is selected in correspondence with the dimensions of the ISO container to be lifted.

The present invention is characterized by its universal applicability for both active picking up and setting down of loads, that is, for traveling over and straddling the ISO container, and for passive load handling, that is, for loading and unloading from above. The unit is thus extremely versatile in application, and it can be operated either automatically or manually. Because the grapplers pick the container up at the lower corner fittings, the straddle loader can operate independently of the height of the container, which is thus no longer relevant to the lifting of the load. After the lifting bolts of the grapplers have been pivoted into the corner fittings of the container and the lifting device has raised it, the container can be held and carried to any desired location.

In a further elaboration of the invention, upper support points for the pivoting grapplers are provided on the longitudinal girders of the lifting device and that downward-pointing brackets are also attached here, to which the pivoting cylinders for the grapplers are hinged. Each of the longitudinal girders of the lifting device is suspended from one of the two longitudinal chassis girders by at least two hydraulic cylinders. The hydraulic cylinders make it possible for the longitudinal girders of the lifting device to be adjusted to any desired height; the kinematics of the grapplers themselves are also supported by the longitudinal girders of the lifting device, on which the pivot points of the grapplers and also the abutments for the actuating cylinders for the grapplers are located.

To ensure the necessary guidance of the lifting device in the transverse direction, in accordance with another feature of the invention, the longitudinal girders of the lifting device have vertically downward- extending support arms for guide rollers, which roll along vertically oriented vertical guides on the longitudinal chassis girders.

According to a preferred embodiment of the invention, downward-extending support arms are attached to the longitudinal chassis girders, and horizontal supports for the bottom of the ISO container are attached to the free ends of these arms. The supports can be moved from a resting position alongside the ISO container to a working position under the bottom of the ISO container. These supports, which can be brought alternately into a working position, make it possible for containers of any size to be set down on them, so that the grapplers, which engage in the corner fittings of the ISO container, serve only to raise and lower the ISO container. During horizontal transport, the ISO container lies on the container supports, where it is secured by, for example, thrust blocks.

The horizontal supports according to the invention are also activated when the straddle loader is loaded and unloaded from above, for which a spreader is normally used, which lowers the ISO container through the open space between the longitudinal chassis girders and sets it down on the supports. The container-lifting grapplers are deactivated in this case.

To ensure that the lifting bolts of the grapplers will reliably engage in the corner fittings of the ISO container, it is provided in accordance with another feature of the invention that the position of the corner fittings can be detected optically and processed in a computer to form a signal for the precision positioning of the straddle loader. The straddle loader is positioned by its traveling mechanism with individual wheel suspension in such a way that the container will be reliably gripped and lifted so that the horizontal supports can be moved in under it.

The straddle loader is preferably equipped with a drive system and a control and navigation system for driverless operation. In this way, the straddle loader can be used as a DTV (driverless transport vehicle) for transporting freight and thus used in completely automated container facilities.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a side view of the straddle loader according to the invention;

FIG. 2 shows a top view of the straddle loader of FIG. 1;

FIG. 3 shows a detail of the straddle loader shown in FIG. 2;

FIG. 4 shows a front view of the straddle loader;

FIG. 5 shows a cross section in the area of one of the vertical guides of the lifting device;

FIGS. 6-11 show the sequence of events which occurs as a container is picked up from the floor; and

FIGS. 12 and 13 show the sequence of events which occurs as a container is picked up from the loaded unit.

### DETAILED DESCRIPTION OF THE PRESENTLY PREFERRED EMBODIMENTS

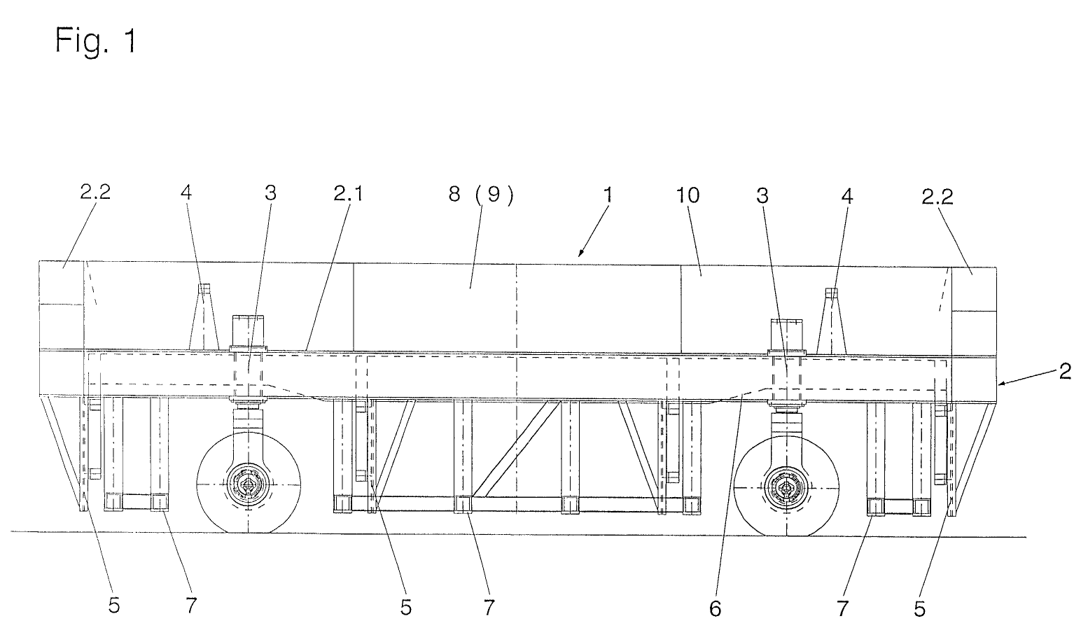

In FIG. 1, the straddle loader 1 includes a chassis 2 having a longitudinal chassis frame 2.1 and portal-like box girders 2.2. The longitudinal chassis frames 2.1 form the base for the individual wheel suspensions of the traveling mechanism 3, for the suspensions 4, for the vertical guides 5, for the lifting device 6, for the container supports 7, for the drive assembly 8, for the electric control panel 9, and for the loading shaft 10. The ends of the straddle loader 1 formed by the portal-like box girders 2.2 are of such a size that the straddling unit can travel over an ISO container with a maximum height of 9′6″.

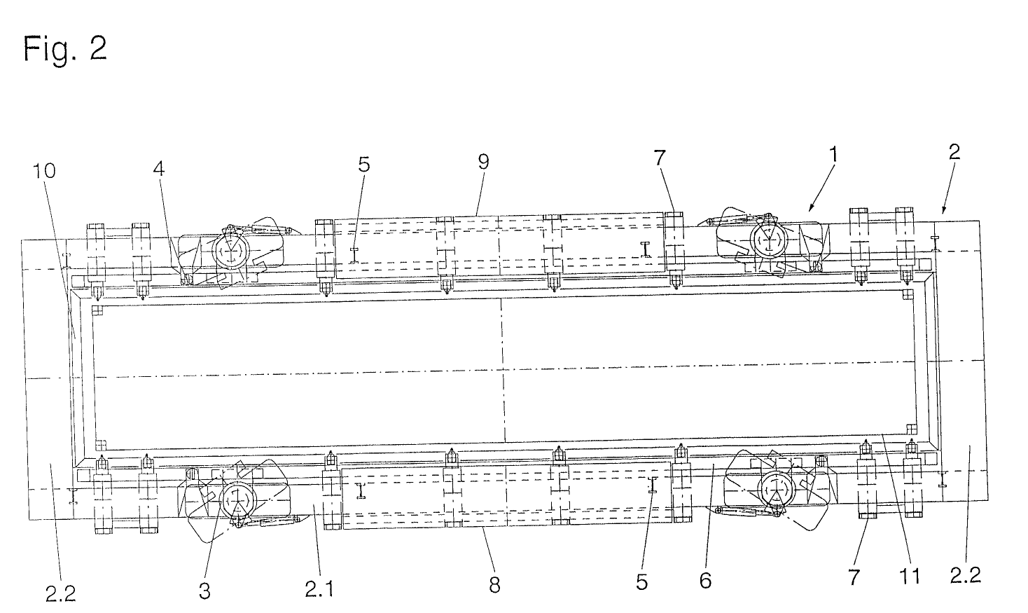

FIG. 2 shows a top view of the straddle loader 1, in which its chassis 2 can be seen. The loading shaft, that is, the open space between the longitudinal chassis frame 2.1 and the girders 2.2, is of such a size that a 45-foot container can be loaded through it from above.

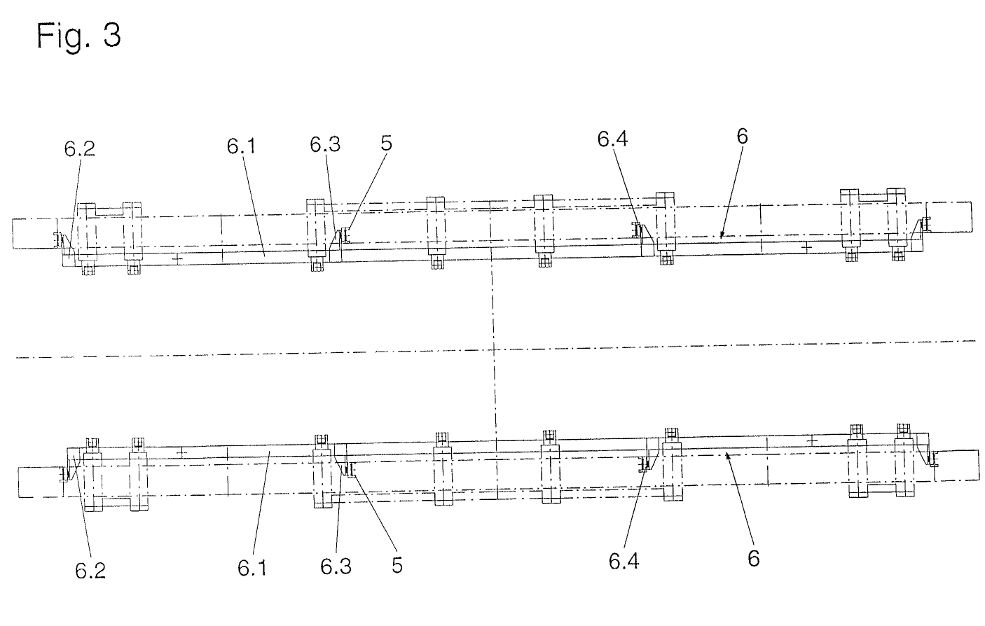

FIG. 3 shows the vertical guides 5 of the lifting device 6. On each of the longitudinal girders 6.1 of the lifting device there are four vertical support arms 6.2. On each support arm, a pair of brackets 6.3 forms the support for a pair of roller guides 6.4.

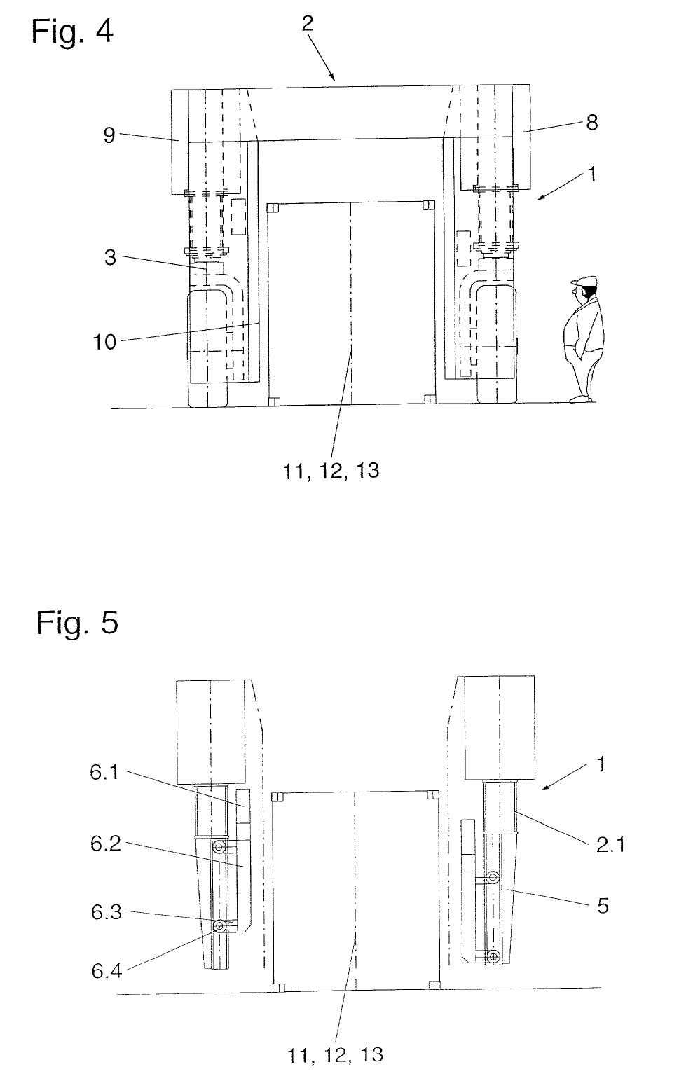

FIG. 4 shows a front view of the straddle loader. The straddle loader 1 with the chassis 2, the traveling mechanism 3, the drive assembly 8, the electrical control panel 9, and the loading shaft 10 can be seen again here. A container 11, 12, or 13 is shown inside the portal.

FIG. 5 is a cross section which shows the straddle loader 1 with the longitudinal chassis frame 2.1 and a vertical guide 5 of the lifting device. Vertical support arms 6.2 are mounted on the longitudinal girders 6.1 of the lifting device. On each support arm, a pair of brackets 6.3 forms the support for a roller 6.4 which rides in a respective guide 5.

The upper end position of the lifting device is shown on the left side of the figure; the lower end position is shown on the right. A container 11 or 12 or 13 is located between the longitudinal girders 6.1 of the lifting device.

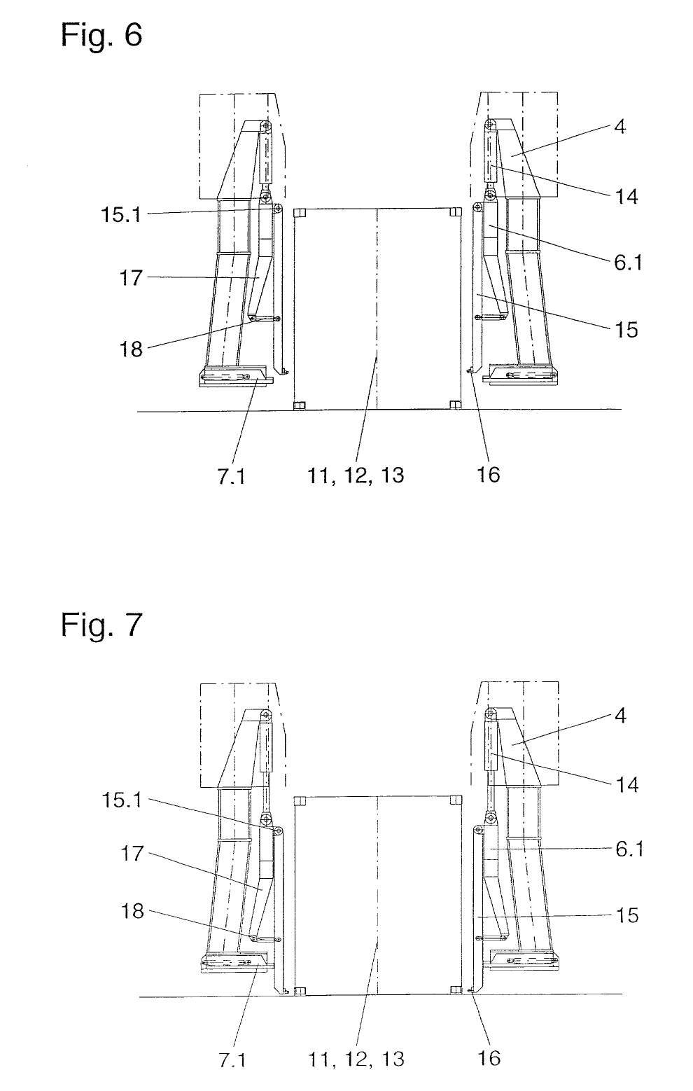

FIGS. 6-11 illustrate and describe the sequence of events which occurs as a container is picked up from the floor. The reverse handling procedure is also possible, but it is not described here in detail.

FIG. 6 shows the suspensions 4 of the lifting device, the lifting cylinders 14, the longitudinal girders 6.1 of the lifting device, the container grapplers 15 with their support points 15.1 and lifting bolts 16 for the containers, and the support brackets 17 of the grappler pivoting cylinders 18. The lifting device is in its upper end position. The container supports 7.1 are deactivated. A container 11 or 12 or 13 is resting on the floor between the container grapplers 15, which are open to the maximum.

FIG. 7 shows the lifting device after it has been lowered by actuation of the lifting cylinders 14 into the lower end position. The container supports 7.1 are deactivated. A container 11 or 12 or 13 is resting on the floor between the container grapplers, which are still open to the maximum.

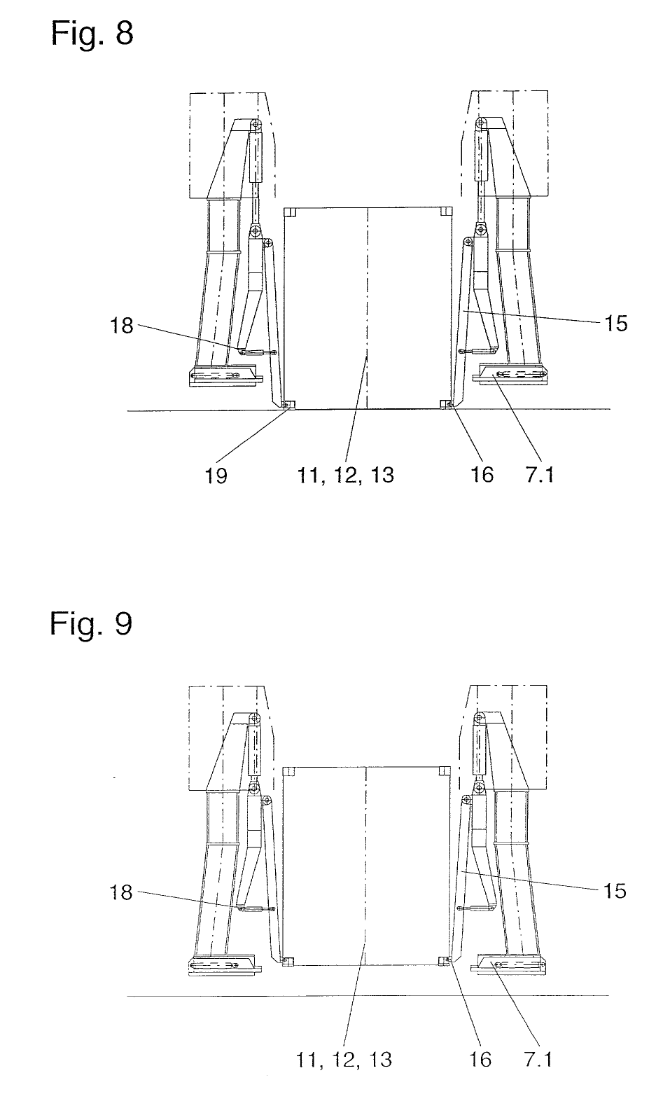

In FIG. 8, the lifting device is still in its lower end position. The container supports 7.1 are deactivated. A container 11 or 12 or 13 is resting on the floor between the container grapplers 15, which have been actuated by the grappler pivoting cylinders 18. The rigid cylindrical lifting bolts 16 at the bottom end of the container grapplers are introduced into the oval openings in the sides of the container corner fittings 19.

As can be seen in FIG. 9, the lifting device has been raised again by actuation of the lifting cylinders 14 and returned to its upper end position. The container supports 7.1 are deactivated. A container 11, 12, or 13 is resting on the rigid, cylindrical lifting bolts 16 between the container grapplers 15, which have been actuated by the grappler pivoting cylinders 18.

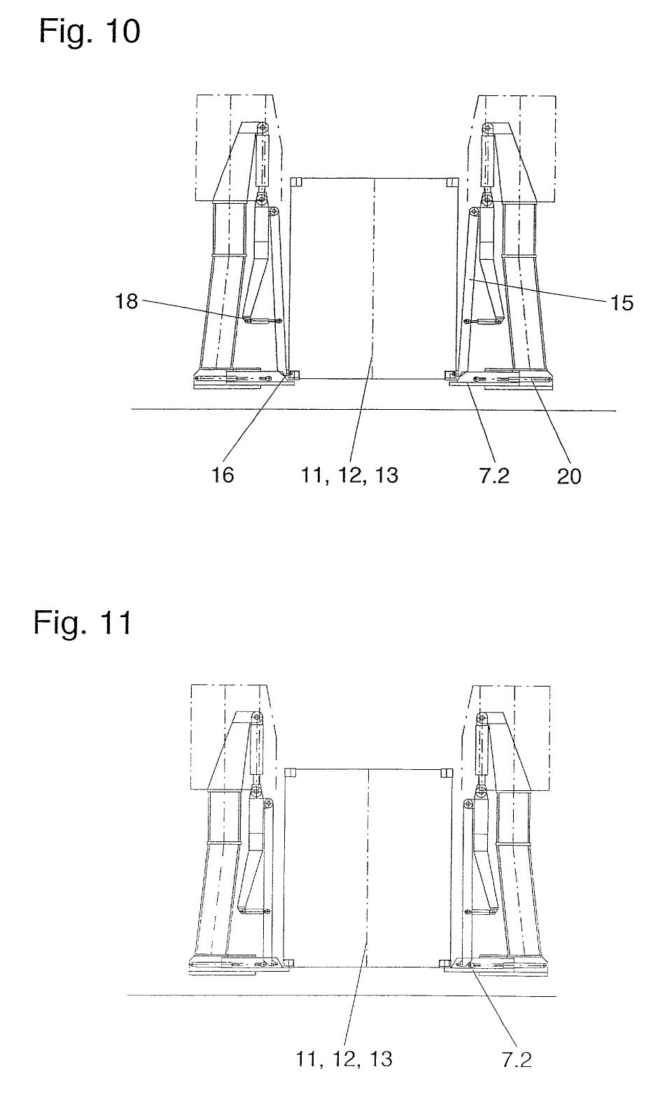

In FIG. 10, the lifting device remains in its upper end position; the container supports 7.2 are now activated by the thrust cylinders 20. A container rests on the rigid cylindrical lifting bolts between the container grapplers 15, which have been actuated by the grappler pivoting cylinders 18. As shown in FIG. 11, the lifting device has been lowered by actuation of the lifting cylinders 14 to a point about 50 mm below the upper end position. The container is resting on the now-active container supports between the container grapplers, which are open to the maximum. In this loaded condition, horizontal transport is now possible.

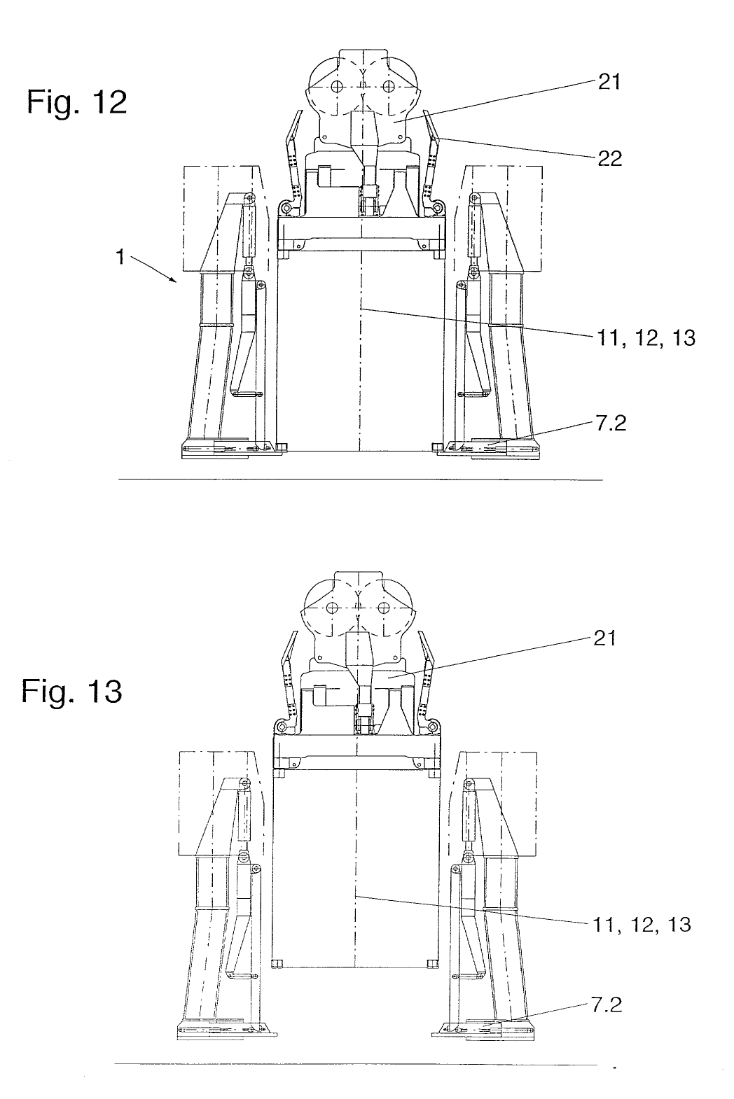

FIGS. 12 and 13 illustrate the sequence of events which occurs when a container is picked up from the loaded unit. The reverse handling procedure is also possible, but it will not be described here.

In FIG. 12, the lifting device is about 50 mm below the upper end position. A container is resting on the activated container support plates 7.2 between the container grapplers 15, which are open to the maximum. The load pickup means, shown here in the form of a spreader 21 with inward-pivoted spreader flippers 22 is ready to lift the container out of the straddle loader 1.

FIG. 13 shows the lifting of the load and thus the further course of the unloading process begun in FIG. 12.

The novel freight transfer system can be used in either automatic or manual mode and is highly flexible in application. It can be used actively; that is, it can be driven over the top of the ISO container to straddle it, but it can also be used passively, that is, loaded and unloaded from above. The straddle loader of the invention thus makes it possible to achieve driverless transport.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A straddle loader for an ISO container, said straddle loader having a longitudinal axis and comprising
a chassis comprising a box girder at each end of the straddle loader, and a pair of longitudinal chassis frames connecting said box girders on either side of said longitudinal axis, said box girders and said longitudinal chassis frames defining therebetween an open space through which said ISO container can be loaded and unloaded from above,
a traveling mechanism comprising individual wheel suspensions mounted to said longitudinal chassis frames so that said traveling mechanism can be positioned on both sides of said ISO container, and
lifting apparatus comprising a pair of longitudinal girders mounted to respective said longitudinal frames symmetrically to the longitudinal axis, said girders being vertically movable relative to said frames, and a plurality of downward extending grapplers hinged to each of said girders for pivoting inward toward said longitudinal axis, said grapplers being arranged to engage in fittings of said ISO container.

2. A straddle loader for an ISO container according to claim 1 wherein said lifting apparatus further comprises
an upper support point for each of said grapplers on said girders,
a downward pointing bracket for each of said grapplers attached to girders, and
a pivoting cylinder for each of said grapplers hinged to each of said brackets.

3. A straddle loader for an ISO container according to claim 2 further comprising at least two hydraulic cylinders suspending each said longitudinal girder from a respective said longitudinal frame.

4. A straddle loader for an ISO container according to claim 1 wherein said lifting apparatus further comprises
a plurality of vertically oriented vertical guides fixed to each of said longitudinal chassis frames,
a plurality of vertically downward extending roller support arms fixed to each of said girders, and
a guide roller journaled to each of said roller support arms and guided by a respective said guide.

5. A straddle loader for an ISO container according to claim 1 further comprising a plurality of downward extending container support arms attached to each of said longitudinal chassis frames, each of said container support arms having a free end with a horizontal support for said ISO container attached thereto, said horizontal supports being movable from a rest position alongside said ISO container to a working position underneath said ISO container.

6. A straddle loader for an ISO container according to claim I further comprising
means for optically detecting the positions of corner fittings of said ISO container, whereby said positions can be processed in a computer to form a signal for the precision positioning of the straddle loader.

7. A straddle loader for an ISO container according to claim 1 further comprising a drive system and a control and navigation system for driverless transport operation.
